(19) United States
(12) Patent Application Publication
(10) Pub. No.: US 2024/0305176 A1
(43) Pub. Date: Sep. 12, 2024

(54) ROTOR FOR AN ELECTRIC MACHINE

(71) Applicant: MAGNA Powertrain GmbH & Co KG, Lannach (AT)

(72) Inventors: Ewald Dohr, St. Michael (AT); Manuel Wohlfahrt, Graz (AT); Helmut Haas, St. Peter a. Ottersbach (AT); Matthias Kohlhauser, Fernitz (AT); Michael Dienbauer, Graz (AT)

(21) Appl. No.: 18/280,759

(22) PCT Filed: Feb. 11, 2022
(86) PCT No.: PCT/EP2022/053367

§ 371 Date: Sep. 7, 2023

(30) Foreign Application Priority Data
Mar. 10, 2021 (DE) 10 2021 202 322.3

(51) Int. Cl. H02K 15/02; F16C 3/02; H02K 1/32

(52) U.S. Cl. CPC H02K 15/028; F16C 3/02; H02K 1/32; F16C 2380/26

(57) ABSTRACT

A rotor for an electric machine includes a rotor core and a rotor shaft. The rotor core is fixed on the rotor shaft. The rotor shaft has, at least in some regions, a non-circular cross-section so that, at least in some regions, a plurality of axially extending channels are formed between the rotor core and a lateral surface of the rotor shaft. At least one region with the non-circular cross-section of the rotor shaft is produced by radial forging without subsequent machining, so that the region with the non-circular cross-section of the rotor shaft has a forging skin. An electric machine may include a rotor of this type. A method for producing a rotor of this type may be performed.

### CROSS-REFERENCE TO RELATED APPLICATIONS

This application is a National Stage of International Application No. PCT/EP2022/053367, filed Feb. 11, 2022, which claims priority to DE 10 2021 202 322.3, filed Mar. 10, 2021. The entire disclosures of each of the above applications are incorporated herein by reference.

### FIELD

The present disclosure relates to a rotor for an electric machine, comprising a rotor core and a rotor shaft, wherein the rotor core is fixed on the rotor shaft, and wherein the rotor shaft has, at least in some regions, a non-circular, in particular polygonal cross-section so that, at least in some regions, a plurality of axially extending channels are formed between the rotor core and a lateral surface of the rotor shaft. Furthermore, the present disclosure relates to an electric machine comprising a stator, a rotor of this type, and a cooling circuit, wherein the axially extending channels of the rotor serve to realize the cooling circuit, and to a method for producing a rotor of this type.

### BACKGROUND

This section provides information related to the present disclosure which is not necessarily prior art.

Electric machines of the type mentioned above are used to convert electrical energy into mechanical energy, and vice versa, and are widely used as motors and/or generators in the field of automotive engineering.

Electric machines comprise a stationary stator and a movable rotor, wherein the rotor in the most common design of an electric machine is mounted rotatably within an annular stator.

During their operation, due to dielectric loss, electric machines generate heat, which on the one hand causes a deterioration in the efficiency of the electric machine and on the other hand negatively affects reliable operation of the electric machine over its service life. Therefore, in drive arrangements with electric machines, a cooling device is usually provided to cool the parts of the electric machine that need to be cooled.

Conventional cooling systems for electric machines use a circulating gaseous or liquid coolant. The coolant circulates, for example, in a housing of the electric machine or in a rotor shaft embodied as a hollow shaft, on which the rotor of the electric machine is arranged. Due to its heat capacity, the coolant absorbs heat and transports it away.

If the coolant is fed through the rotor shaft, radial bores are often provided in the lateral surface of the rotor shaft in the end regions of the rotor shaft, via which the winding heads in particular can be supplied with coolant. However, it is particularly difficult to supply the radial bores with coolant in accordance with a fixed ratio. Furthermore, the radial installation space of electric machines is often limited and the rotor shaft, which is embodied as a hollow shaft, may only have a very small inner diameter, which further impairs the efficiency of the cooling.

### SUMMARY

This section provides a general summary of the disclosure, and is not a comprehensive disclosure of its full scope or all of its features.

It is an object of the present disclosure to provide an improved rotor for an electric machine. It is a further object of the present disclosure to describe an electric machine comprising a rotor according to the present disclosure, which is distinguished by improved rotor cooling, lower hydraulic losses and thus a higher efficiency than electric machines having comparable cooling concepts, and also to describe a method for producing such a rotor.

This need can be met by the subject matter of the present disclosure as described herein. Advantageous embodiments of the present disclosure are also described.

The rotor according to the present disclosure comprises a rotor core and a rotor shaft, wherein the rotor core is fixed on the rotor shaft, i.e. arranged thereon in an axially fixed manner and non-rotatably. According to the present disclosure, the rotor shaft has, at least in some regions, a non-circular cross-section so that, at least in some regions, a plurality of axially extending channels are formed between the rotor core and a lateral surface of the rotor shaft. According to the present disclosure, at least one region with a non-circular cross-section of the rotor shaft is produced by way of radial forging without subsequent machining, so that the region with non-circular cross-section of the rotor shaft has a forging skin.

According to the present disclosure, the production of cooling channels of an electric motor rotor by way of a radially forged polygonal rotor shaft is carried out by a “net shape” production, so that no machining is carried out, at least in the region or regions of the cross-section of the rotor shaft which are not circular arc-shaped, but are preferably flat. By forming the rotor shaft in this manner, the rotor shaft is distinguished from post-machined rotor shafts, by the component geometry created and by the surface finish imparted to the rotor shaft by the radial forging process. Also, usually a “net shape” raw surface is matte, while a machined surface is shiny.

Due to the existing forging skin, the cooling channels have particularly good mechanical and chemical properties, such as strength and resistance even to more aggressive cooling media in the cooling channels, and the cooling channels can be produced very economically and without waste.

According to the present disclosure, a rotor shaft starting material (extruded blank, tube, etc.) is radially forged (kneaded), preferably by switching off the workpiece speed during the manufacturing process, so that, depending on the process, a 4-fold polygonal shape with 4 flats is produced, for example with 4 forging hammers, and generally an n-fold polygonal shape with n flats is produced with n forging hammers. These flats are not further machined and, together with preferably pressed-on rotor cores with a circular inner diameter, form axial cooling channels.

The starting material for the production of the rotor shaft can be a tube open at both ends or an extruded blank closed at one end. Component reshaping (diameter reduction, axial expansion) can be performed by radial forging at a workpiece speed. A final radial forging process step can be performed by switching off the workpiece speed and radial infeed and axial feed. This can be followed by pressing on a rotor stack or rotor core. This produces a finished rotor already with axial cooling channels.

Within the scope of the present disclosure, the radially forged, unmachined contours are strengthened and the forging skin of the starting material is retained. This makes it possible to form complex geometries, for example polygonal shapes, a near-net-shape component design, and thus cost savings due to reduced mechanical machining. An economical manufacture of cooling channels for the optimization of thermally highly loaded rotors and thus a reduction of the magnet temperature in permanent-magnet synchronous machines is made possible.

The directional specification “axial” corresponds to a direction along or parallel to a central axis of rotation of the rotor shaft. The directional specification “radial” corresponds to a direction normal to the axis of rotation of the rotor shaft.

According to the present disclosure, a “region”, which can be circular or non-circular, for example, corresponds to a portion along the circumference of the rotor shaft. A portion of the circumference can thus be circular, more precisely circular-arc-shaped, or non-circular, more precisely non-circular-arc-shaped.

Preferably, at least one region with a circular cross-section of the rotor shaft was machined after radial forging of the rotor shaft so that the region with a circular cross-section of the rotor shaft has no forging skin. This ensures an exact fit when the rotor core is pressed onto the rotor shaft.

The rotor shaft preferably has a polygonal cross-section at least in some regions. A polygonal cross-section is an example of a non-circular cross-section.

The rotor shaft can be at least partially hollow with a central cavity and can have at least one radially running transverse bore that connects the central cavity directly or indirectly, for example via a channel which is ring-shaped in cross-section, namely an annular channel, to at least one axially extending channel between the lateral surface of the rotor shaft and the rotor core.

The rotor shaft can be formed in one part or in multiple parts, wherein the individual parts of the multi-part rotor shaft are fixedly connected to each other.

The rotor shaft preferably has a first portion, a second portion and a third portion, wherein the second portion lies in an axial direction between the first portion and the third portion. Preferably, the rotor core is fixed on the rotor shaft in the region of the second portion. Further preferably, the second portion has the non-circular, in particular polygonal cross-section, so that a plurality of axially extending channels are formed between the rotor core and the lateral surface of the rotor shaft in the region of the second portion of the rotor shaft.

A fluid supply path and/or a fluid discharge path is preferably formed in the region of the first portion and/or the second portion and/or the third portion of the rotor shaft.

Particularly preferably, the central cavity forms the fluid supply path and/or the fluid discharge path.

In an advantageous variant of the present disclosure, the central cavity of the rotor shaft extends through the first portion into the second portion of the rotor shaft and forms a fluid supply path, wherein the central cavity is connected to the lateral surface of the rotor shaft in the region of at least one axially running channel via at least one radially running transverse bore.

In a preferred variant of the present disclosure, an end cap is fixed on the rotor shaft in the region of the first portion and/or in the region of the third portion, adjacently to the second portion and thus to the rotor core.

The end cap is preferably designed in such a way that a channel which is ring-shaped in cross-section, i.e. an annular channel, is formed radially between the rotor shaft and the end cap, wherein the ring-shaped channel is connected, on the one hand, to the axially running channels in the region of the second portion of the rotor shaft and, on the other hand, is connected to the central cavity in the region of the first portion of the rotor shaft and/or in the region of the third portion of the rotor shaft via at least one radially running transverse bore in the first portion of the rotor shaft and/or in the third portion of the rotor shaft, wherein the central cavity forms the fluid supply path and/or the fluid discharge path.

In a further advantageous variant of the present disclosure, the rotor shaft is formed in multiple parts, wherein a fluid-conducting element is formed or arranged in the axial direction between the individual parts of the rotor shaft.

The rotor shaft is preferably designed here in such a way that a fluid-conducting element is arranged axially between the first portion and the second portion of the rotor shaft and/or axially between the second portion and the third portion of the rotor shaft.

The fluid-conducting element is preferably circular in cross-section and has a further ring-shaped channel, i.e. an annular channel, and at least one radially running transverse bore in the region of its outer circumference. The radially running transverse bore in the fluid-conducting element connects the central cavity of the rotor shaft in the region of the first portion and/or the third portion of the rotor shaft to the further ring-shaped channel, wherein the further ring-shaped channel is further connected to the axially extending channels in the region of the second portion of the rotor shaft.

The electric machine according to the present disclosure comprises a stator, a rotor according to the present disclosure, and a cooling circuit, wherein the axially extending channels of the rotor according to the present disclosure serve to realize the cooling circuit.

The method for producing the rotor according to the present disclosure comprises that at least one region, preferably all regions with non-circular cross-section of the rotor shaft, is produced by radial forging without subsequent machining, wherein the blank is not rotated in a final radial forging operation.

At least one region, preferably all regions with a circular cross-section of the rotor shaft, are machined after radial forging of the rotor shaft.

The method according to the present disclosure serves to produce a shaft which is at least partially non-circular in cross-section, namely preferably partially polygonal at the outer circumference, from a substantially cylindrical blank by way of radial forging.

In accordance with the present disclosure, the blank is not rotated in a final radial forging operation.

The blank may be a tube open at both ends or an extruded blank closed at one end.

Preferably, the method comprises at least the following further steps chronologically before the final radial forging operation:
providing a substantially cylindrical blank,
radially forging at least one shaft portion with the blank rotating.

In the context of the present disclosure, a “final radial forging operation” may be understood to mean a final forging operation, chronologically after forging operations already preceding it, but also a single forging operation without the blank having previously passed through a forging operation.

The method according to the present disclosure makes it possible to realize complex external geometries, namely polygonal shapes, of a shaft in a simple manner. Furthermore, a near-net-shape component design is made possible and thus a cost saving is achieved through a reduced mechanical post-machining effort.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

The present disclosure is described below by way of example with reference to the drawings:

FIG. 1 shows a schematic representation of an electric machine.

FIG. 2 shows an isometric representation of a polygonal rotor shaft.

FIG. 3 shows a schematic representation of a rotor in a first variant in a longitudinal section.

FIG. 4 shows a schematic representation of a rotor according to FIG. 2 in a cross-section along the sectional plane A-A.

FIG. 5 shows a schematic representation of a rotor according to FIG. 2 in a cross-section along the sectional plane B-B.

FIG. 6 shows a schematic representation of a rotor in a second variant in a longitudinal section.

FIG. 7 shows a schematic representation of a rotor in a third variant in a longitudinal section.

FIGS. 8a, 8b, 8c each show a schematic representation of transverse bores in different variants.

FIGS. 9a-9e each show a schematic representation of an axially running channel in different variants.

FIG. 10 shows a schematic detail of a multi-part rotor shaft with a fluid-conducting element.

FIG. 11 shows a schematic representation of a rotor with a seal.

FIG. 12 shows a schematic representation of an exemplary blank before a forging process.

FIG. 13 shows a schematic representation of an exemplary blank according to FIG. 12 after a first and a second forging operation with a first and a second inner diameter as well as a first and a second outer diameter.

FIG. 14 shows a schematic representation of an exemplary shaft after a first and a second forging operation as well as a final forging operation in which the blank was not rotated.

FIG. 15 shows a cross-sectional view along the plane of section A-A according to FIG. 14.

FIG. 16 shows a perspective view of a blank and the forging tools.

FIG. 17 shows a frontal view of FIG. 16 in the viewing direction of the directional arrow 107.

FIG. 18 shows a three-dimensional representation of a rotor shaft of a rotor.

FIG. 19 shows a three-dimensional representation of a detail of the rotor shaft according to FIG. 18.

FIG. 20 shows a sectional representation of the rotor shaft according to FIG. 18.

FIG. 21 shows a sectional representation of a rotor according to the present disclosure with a rotor shaft according to FIG. 18.

### DETAILED DESCRIPTION

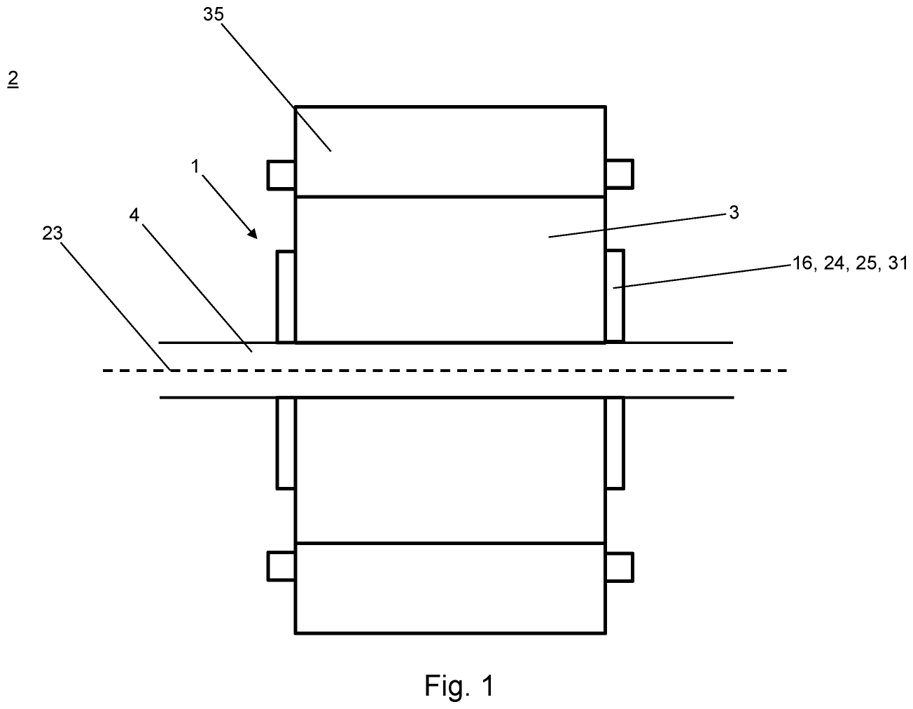

In FIG. 1, an electric machine 2 is shown schematically. The electric machine 2 comprises a rotor 1, a stator 35, and a cooling circuit (not shown). The stator 35 surrounds the rotor 1 around its outer circumference. The rotor 1 is designed to be rotatable about an axis of rotation 23 and has a rotor core 3 and a rotor shaft 4.

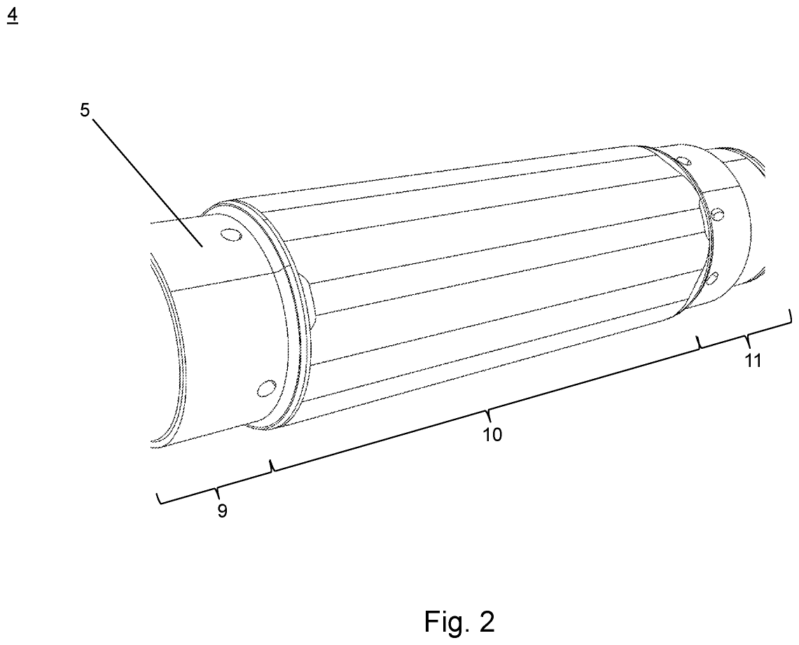

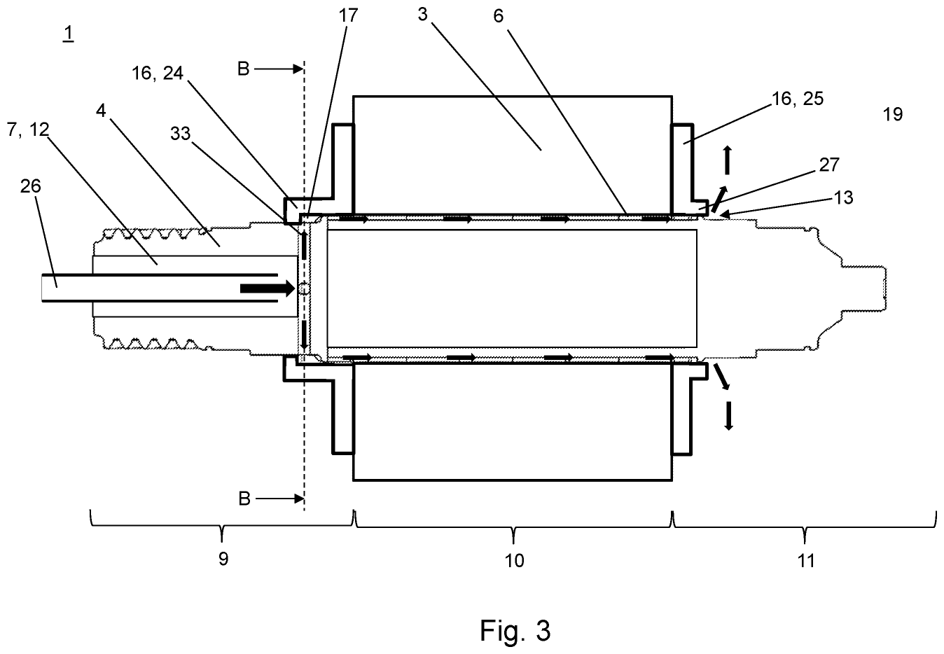

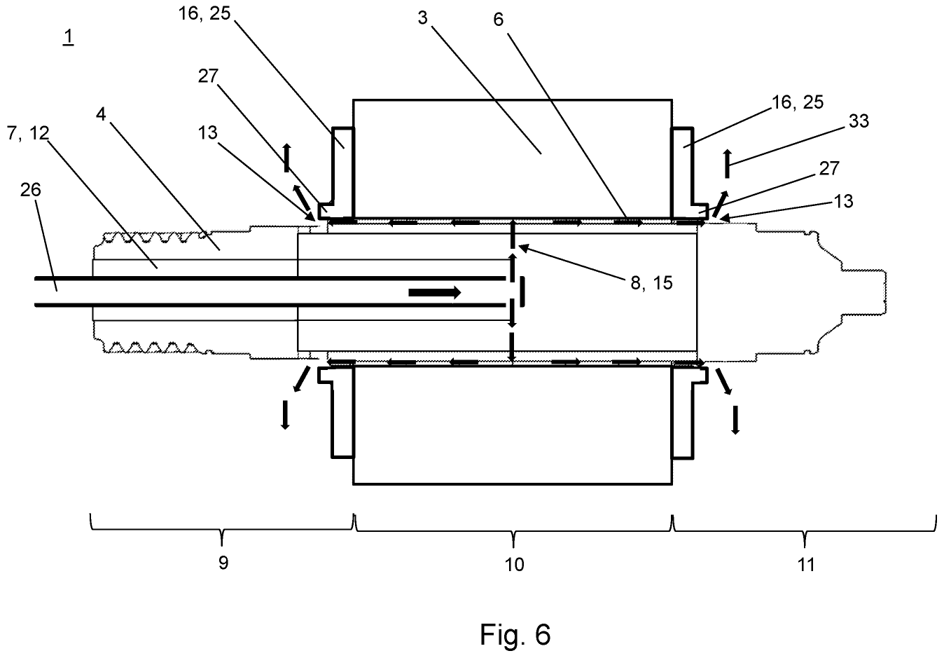

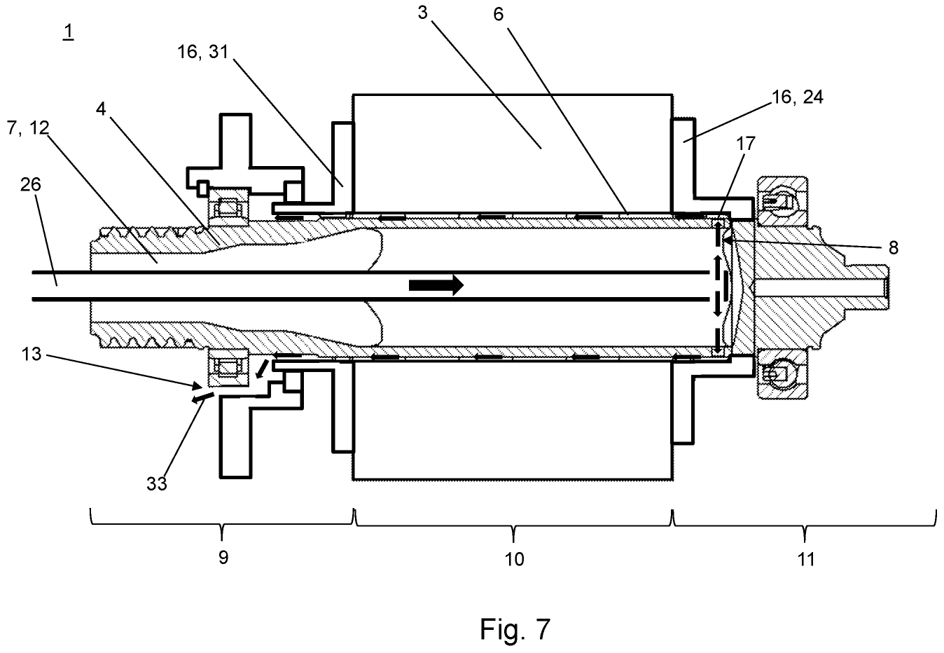

FIG. 2 shows an isometric view of a rotor shaft 4 which is non-circular in cross-section. In the present case, the rotor shaft 4 has a polygonal shape with four-fold symmetrical flattening in the axial direction. FIG. 3, FIG. 6 and FIG. 7 each show an exemplary variant of a rotor 1 comprising such a rotor shaft 4 in a longitudinal section. Such a rotor 1 is used in the electric machine 2.

In general, regardless of the variant, the rotor 1 comprises a rotor core 3 and a rotor shaft 4 (FIG. 3, FIG. 6, FIG. 7).

The rotor shaft 4 is at least partially hollow with a central, axially running cavity 7. The central cavity 7 is connected to the lateral surface 5 of the rotor shaft 4 via at least one radial transverse bore 8.

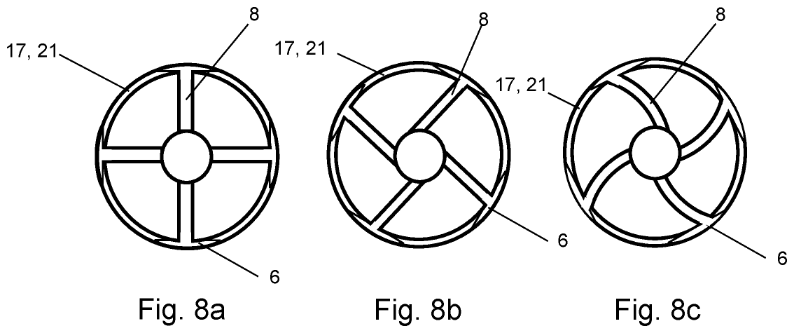

The radial transverse bore 8 can have appropriately designed geometries depending on the requirements or system properties, for example to keep hydraulic losses and required pumping powers low. The transverse bore 8 can be straight here along its transverse extent (FIG. 8a), i.e., normal to the axis of rotation 23 (FIG. 8b), slanted, i.e., oblique to the axis of rotation 23, or curved (FIG. 8c), i.e., turbine-shaped. Furthermore, the diameter of the transverse bore 8 can be adapted to the system requirements.

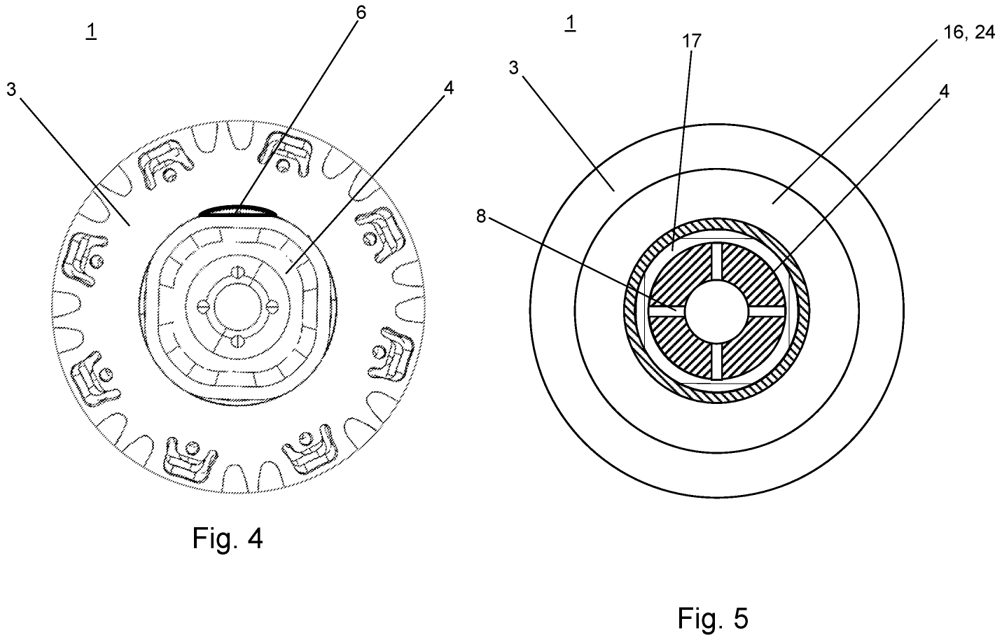

The rotor shaft 4 has a first portion 9, a second portion 10 and a third portion 11, wherein the second portion 10 lies in an axial direction between the first portion 9 and the third portion 11 (FIG. 2). In the region of the second portion 10, the rotor core 3 is fixed on the rotor shaft 4, i.e., arranged thereon in an axially fixed manner and non-rotatably. The second portion 10 of the rotor shaft 4 has the non-circular, namely polygonal cross-section-a plurality of axially extending channels 6 are thus formed between the rotor core 3 and a lateral surface 5 of the rotor shaft 4 in the region of the second portion 10 of the rotor shaft 4 (FIG. 3, FIG. 4, FIG. 6, FIG. 7). The axially extending channels 6 serve to realize the cooling circuit of the electric machine 2.

The directional specification “axial” corresponds to a direction along or parallel to a central axis of rotation 23 of the rotor shaft 4. The directional specification “radial” corresponds to a direction normal to the axis of rotation 23 of the rotor shaft 4.

The resulting partially flat design of the channels 6 and thus optimized wetted surface is ideal for high-speed rotor shafts 4—the cooling medium can dissipate the heat loss directly below the rotor core 4 in the best possible way. This increases the performance of the electric machine 2, as the rotor core temperature is lowered and thus higher powers are achieved until the critical temperatures are reached. This becomes more important with increasing speed/power.

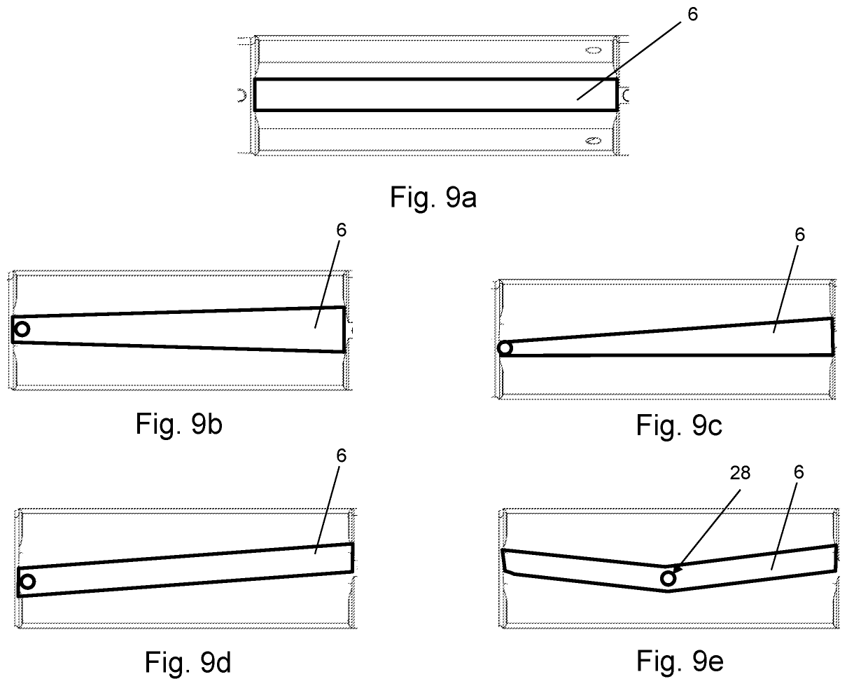

The axially extending channels 6 can have a constant cross-section (FIG. 9a) or a variable cross-section (FIG. 9b, FIG. 9c) along their longitudinal extent. Furthermore, the axially extending channels 6 can have a straight, arbitrarily oblique, or curved geometry along their longitudinal extent (FIG. 9d, FIG. 9e). In addition, the orientation of the axially extending channels 6 in relation to the inflow of the fluid and to the direction of rotation of the rotor shaft 4 can also be taken into account insofar as cooling effect, hydraulic losses and fluid velocity form an optimum in relation to the total output of the electric machine 2. This is to be considered in particular in relation to different operating modes of the electric machine 2 (forward/reverse, pull/push, acceleration/constant speed). Basically, higher fluid velocities are preferred in order to guide enough “cold” fluid past the rotor core 3.

During operation, the centrifugal forces from the rotation of the rotor shaft 4 promote a homogeneous distribution and wetting of the rotor core 3 with fluid. Accordingly, a venting channel remains between the fluid film and the rotor shaft 4, preventing fluid build-up in the system.

If the individual portions 9, 10, 11 of the rotor shaft 4 of the exemplary variants according to FIG. 3, FIG. 6 and FIG. 7 are functionally arranged as a component of the rotor 1 of the electric machine 2, the connection to a gear region, a bearing of the rotor shaft 4 and a fluid supply, and/or fluid discharge can be found in the region of the first portion 9. The center piece or the second portion 10 of the rotor shaft 4 transmits the torque to or from the rotor core 3 and serves to feed fluid through the rotor 1. The third portion 11 can also be assigned a bearing of the rotor shaft 4 and a fluid feed and/or a fluid discharge and/or a fluid return.

The fluid is oil from a fluid reservoir. For example, the oil may be conveyed from the fluid reservoir via a fluid line to a fluid supply path 12 of the rotor shaft 4 of the rotor by way of a pump, such as a mechanical pump or an electric pump. A fluid discharge path 13 of the rotor shaft 4 of the rotor 1 is connected to the external environment of the rotor 1 of the electric machine 2, a fluid conduit, and/or to the central cavity 7 of the rotor shaft 4 of the rotor 1.

Three exemplary variants of a rotor 1 according to FIG. 3 to FIG. 7 are explained below. The flow direction of a fluid is always indicated by arrows 33.

FIG. 3 shows a rotor 1 in a first variant. FIG. 4 and FIG. 5 each show the rotor 1 from FIG. 3 in a cross-sectional view along different sectional planes.

In the first variant shown in FIG. 3, the fluid supply path 12 is formed via a central cavity 7 in the region of the first portion 9 of the rotor shaft 4. In the present exemplary embodiment, the fluid supply path is formed via a rotor lance 26 with a corresponding diameter-length ratio. The rotor lance 26 can also have an orifice plate for limiting fluid flow.

In the region of the first portion 9 and in the region of the third portion 11, adjacent to the second portion 10 and thus to the rotor core 3, an end cap 16—in the region of the first portion 9 a first end cap 24 and in the region of the third portion 11 a second end cap 25—is fixed on the rotor shaft 4 in each case.

The first end cap 24 is designed in such a way that a channel 17 which is ring-shaped in cross-section, i.e., an annular channel, is formed radially between the rotor shaft 4 and the first end cap 24, wherein the annular channel 17 is connected, on the one hand, to the four axially extending channels 6 in the region of the second portion 10 of the rotor shaft 4 and, on the other hand, is connected to the central cavity 7 in the first portion 9 of the rotor shaft 4, i.e., the fluid supply path 12, via four radially running transverse bores 8 in the first portion 9 of the rotor shaft 4 (FIG. 5). Via the annular channel 17 between the radially running transverse bores 8 and the axially extending channels 6, the most uniform possible filling of the axially extending channels 6 is achieved after central supply of the fluid via the central cavity 7 in the first portion 9 of the rotor shaft 4. The annular channel 17 thus enables pressure equalization and homogeneous distribution of the fluid.

The second end cap 25 has a bore and a centrifugal lug 27 adjoining the bore, via which the fluid emerging from the axially extending channels 6 is centrifuged in a targeted manner in the direction of a stator winding head of the electric machine 2. The bore represents a fluid discharge path 13.

In the shown first exemplary embodiment according to FIG. 3 to FIG. 5, the charging of the rotor shaft 4 with fluid takes place from one side, specifically in the region of the first portion 9 of the rotor shaft 4—the fluid flow is schematically shown in FIG. 3 via the arrows 33. This approach minimizes the mass inertia as well as hydraulically and dynamically disadvantageous effects.

When using a rotor 1 according to the first variant (FIG. 3, FIG. 4, FIG. 5) in an electric machine 2, a so-called “wet” electric machine 2 is generated.

FIG. 6 shows a rotor 1 in a second variant.

In the second variant shown in FIG. 6, the central cavity 7 of the rotor shaft 4 extends through the first portion 9 partially into the second portion 10 of the rotor shaft 4. In this second variant, the fluid supply path 12 is formed via the central cavity 7 in the region of the first portion 9 and the second portion 10 of the rotor shaft 4. In the second portion 10 of the rotor shaft 4, there are formed a number of radially running transverse bores 8, i.e., four, corresponding to the number of axially extending channels 6. The central cavity 7 is connected to the lateral surface 5 of the rotor shaft 4 in the region of an axially running channel 6 via a radially running transverse bore 8 in each case. In the present, second exemplary embodiment, the axially running channels 6 each have an oblique geometry along their longitudinal extent, namely an arrow-shaped geometry in a plan view of the respective channel 6 (FIG. 9e). The radially running transverse bores 8 each open out starting from the central cavity 7 in the region of the tip 28 of the arrow-shaped geometry of the axially extending channels 6 (FIG. 9e).

In the present second exemplary embodiment, fluid is supplied via a rotor lance 26 having a corresponding diameter-length ratio, wherein the rotor lance 26 extends through the central cavity 7 in the first portion 9 of the rotor shaft 4 into the central cavity 7 in the second portion 10 of the rotor shaft 4. The rotor lance 26 may also include an orifice plate for limiting fluid flow.

In the region of the first portion 9 and in the region of the third portion 11 of the rotor shaft 4, adjacent to the second portion 10 and thus to the rotor core 3, an end cap 16 is fixed on the rotor shaft 4 in each case.

The end caps 16 correspond in their design to the second end cap 25 of the first variant according to FIG. 3 to FIG. 5 and each have a bore and a centrifugal lug 27 adjoining the bore, via which the fluid emerging from the axially extending channels 6 is centrifuged in a targeted manner in the direction of a stator winding head of the electric machine 2. The bore represents a fluid discharge path 13.

In the second exemplary embodiment shown in FIG. 6, the rotor shaft 4 is fed with fluid from one side in the region of the second portion 10 of the rotor shaft 4, specifically centrally in this second portion 10—the fluid flow is shown schematically in FIG. 6 via the arrows 33. Here, starting from the center of the second portion 10 of the rotor shaft 4, a counter-rotating flow through the channels 6 is achieved—the fluid is divided in the rotor shaft 4 and pumped from both sides in counter-rotation via the channels 6 by the centrifugal force.

When using a rotor 1 according to the second variant (FIG. 6) in an electric machine 2, a so-called “wet” electric machine 2 is also generated.

FIG. 7 shows a rotor 1 in a third variant.

In the third variant shown in FIG. 7, the central cavity 7 of the rotor shaft 4 extends through the first portion 9 and the second portion 10 partially into the third portion 11 of the rotor shaft 4. In this third variant, the fluid supply path 12 is formed via the central cavity 7 in the region of the first portion 9, the second portion 10, and the third portion 11 of the rotor shaft 4.

In the region of the first portion 9 and in the region of the third portion 11 of the rotor shaft 4, adjacent to the second portion 10 and thus to the rotor core 3, an end cap 16—in the region of the third portion 9 a first end cap 24 and in the region of the third portion 11 a third end cap 31—is fixed on the rotor shaft 4 in each case.

The first end cap 24 is designed in such a way that the channel 17, which is ring-shaped in cross section, is formed radially between the rotor shaft 4 and the first end cap 24, wherein the annular channel 17 is connected, on the one hand, to the axially running channels 6 in the region of the second portion 10 of the rotor shaft 4 and, on the other hand, to the central cavity 7 via four radially extending transverse bores 8 in the third portion 11 of the rotor shaft 4 (FIG. 7). Via the annular channel 17 between the radially running transverse bores 8 and the axially extending channels 6, the most uniform possible filling of the axially extending channels 6 is achieved after central supply of the fluid. The annular channel 17 thus enables pressure equalization and homogeneous distribution of the fluid.

In the present third exemplary embodiment, the fluid is supplied via a rotor lance 26 having a corresponding diameter-length ratio, wherein the rotor lance 26 extends via the central cavity 7 in the first portion 9 of the rotor shaft 4, the central cavity 7 in the second portion 10 of the rotor shaft 4, and into the central cavity 7 in the third portion 11 of the rotor shaft 4. The rotor lance 26 may also have an orifice plate for limiting fluid flow.

The third end cap 31 has a bore via which the fluid emerging from the axially extending channels 6 in the region of the first portion 9 of the rotor shaft 4 can be directed in a targeted way, for example, to a gear assembly. The bore represents a fluid discharge path 13.

In the shown third exemplary embodiment according to FIG. 7, the charging of the rotor shaft 4 with fluid takes place from one side, specifically in the region of the third portion 11 of the rotor shaft 4—the fluid flow is schematically shown in FIG. 3 via the arrows 33.

When using a rotor 1 according to the third variant (FIG. 7) in an electric machine 2, a so-called “dry” electric machine 2 is generated.

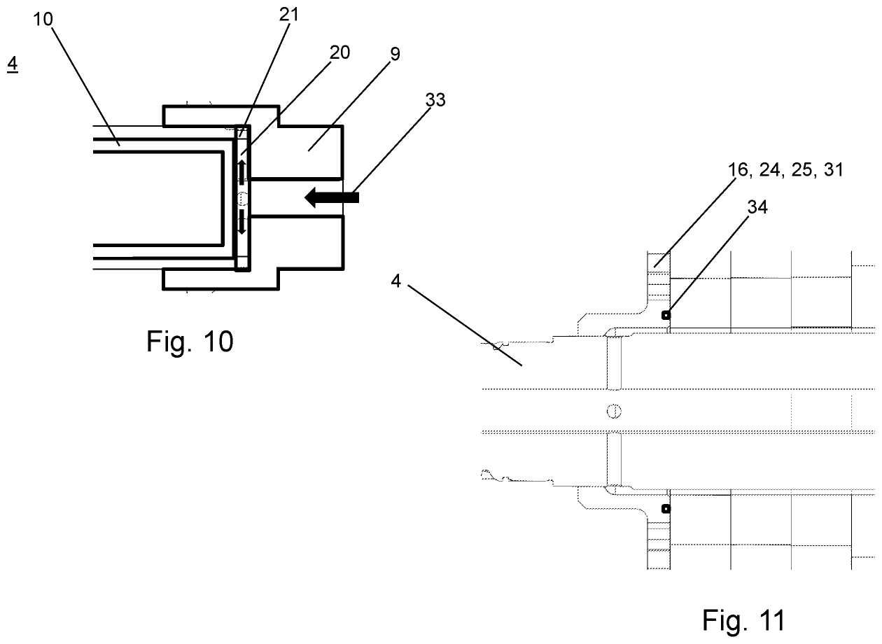

FIG. 10 shows a detailed representation of a multi-part rotor shaft 4, wherein the individual parts of the multi-part rotor shaft 4 are fixedly connected to one another. As shown by way of example in FIG. 10, the first portion 9 of the rotor shaft 4 represents a first part, and the second portion 10 and the third portion 11 (not shown) of the rotor shaft 4 together represent a second part of the multi-part rotor shaft 4.

In the axial direction, a fluid-conducting element 20 is arranged between the first portion 9 of the rotor shaft 4, i.e., the first part, and the combined second portion 10 and third portion 11 of the rotor shaft 4, i.e., the second part.

The fluid-conducting element 20 is circular in cross-section and has, in the region of its outer circumference, a further ring-shaped channel 21, i.e., a further annular channel, and at least one radially running transverse bore 8. In the present example, the radially running transverse bore 8 in the fluid-conducting element 20 connects the fluid supply path 12 and/or the fluid discharge path 13, formed via a central cavity 7 in the first portion 9 of the rotor shaft 4, to the further annular channel 21. The further annular channel 21 is additionally connected to the axially extending channels 6 in the region of the second portion 10 of the rotor shaft 4.

FIG. 11 shows a detailed representation of an exemplary rotor shaft 4 with an end cap 16, wherein the end cap 16 comprises a sealing element 34. The sealing element 34 serves to seal the cooling circuit in the region of the end cap 16.

In the present document, the term “connected” is understood to mean “fluid-connected” in the context of a fluid line.

There are various manufacturing approaches for producing the rotor shaft 4, wherein a differentiation can be made between single-part and multi-part variants. A single-part rotor shaft 4 is produced in one piece by, for example, forging, hammering, etc. from a semi-finished product and has (expediently) a polygonal outer geometry as well as a central cavity inside the rotor shaft 4. Teeth, bearing seats, transverse bores, etc. are formed subsequently. In the case of multi-part rotor shafts 4, at least one individual part, such as the first portion 9 (FIG. 10) and/or the third portion 11, is applied to another individual part, for example the second portion 10 of the rotor shaft 4, in a joining process (for example laser welding). It is essential that the center piece, for example the second portion 10 of the rotor shaft 4, has features for fluid guidance, namely, for example, the axially extending channels 6. The channels 6 in the region of the second portion 10 of the rotor shaft 4 can be formed mechanically either directly during the manufacturing of the center piece or subsequently. Manufacturing processes that may be used include extrusion, forging, hammering, milling and other processes. The channel shape depends on the manufacturing process for the rotor shaft 4, the torque to be transmitted and the fluid quantity. The number of channels 6 can vary, but it is expedient to regard them as symmetrical.

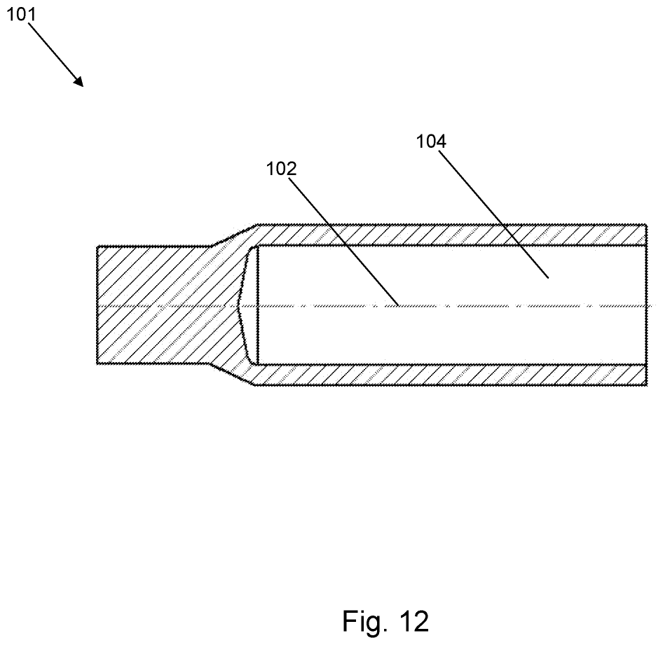

The following describes an exemplary radial forging process, from which a shaft 108 with a partially polygonal outer circumference is generated. In FIG. 12 to FIG. 15, individual formation stages of the blank 101 or of the shaft 108 are shown for this purpose.

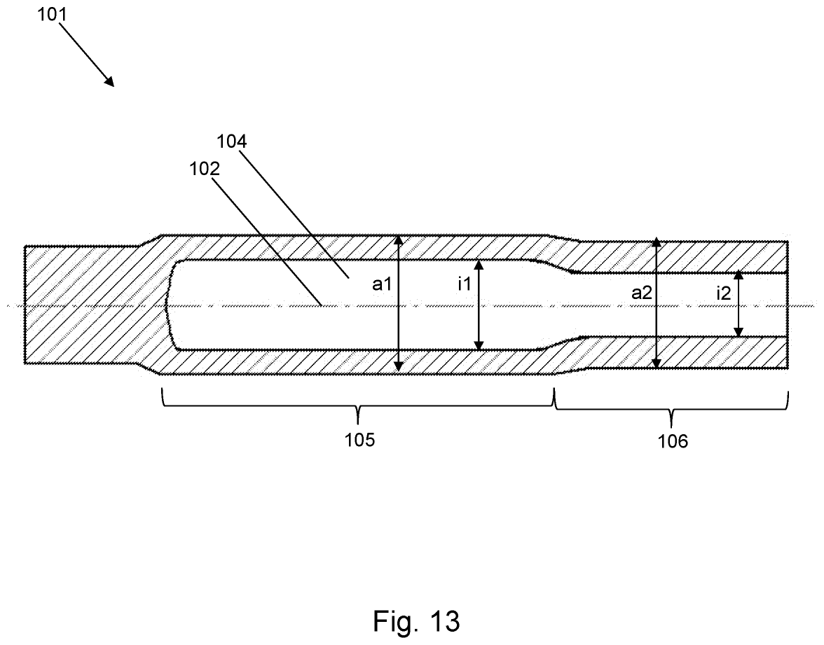

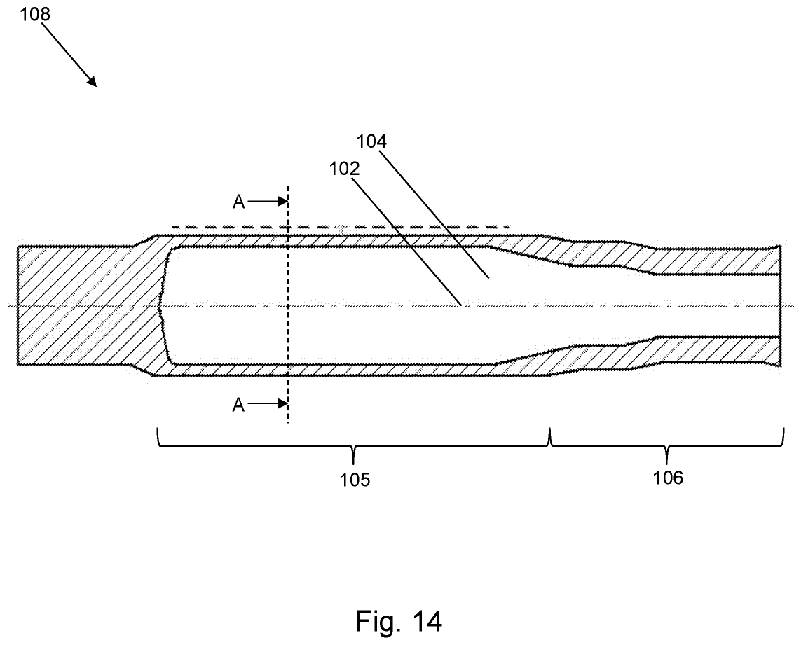

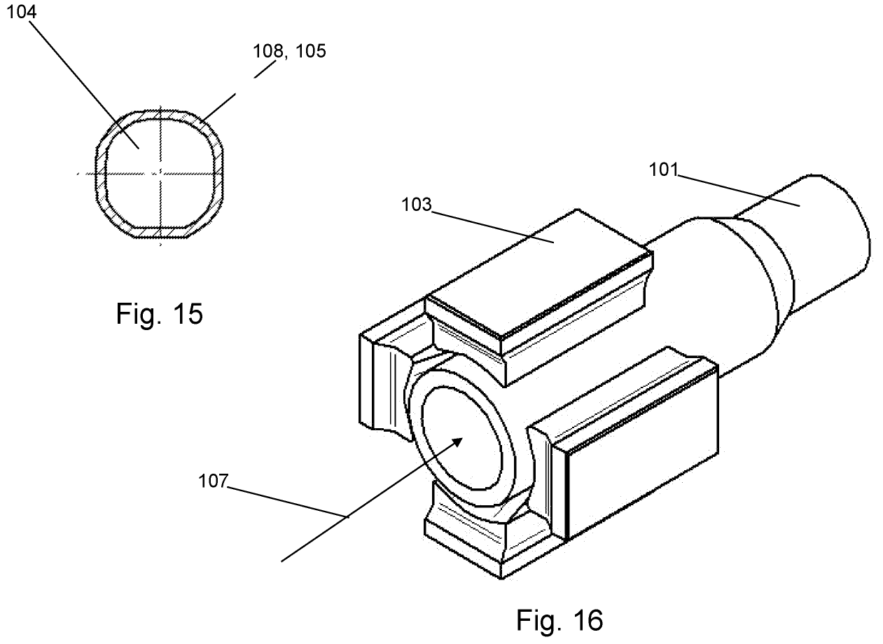

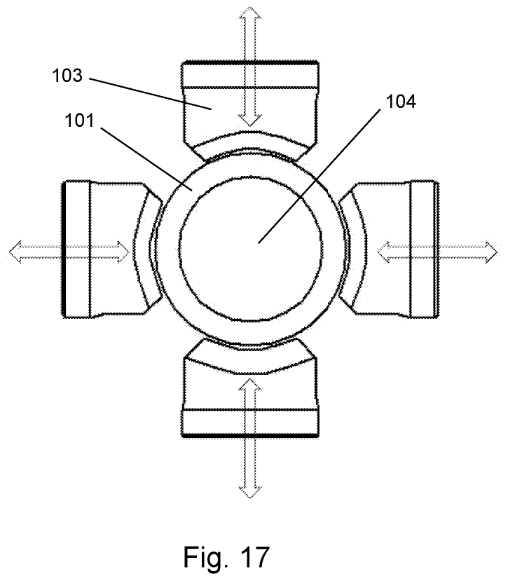

For example, FIG. 12 shows a blank 101 before radial forging operations and FIG. 13 shows a blank 101 after a first forging operation and a second forging operation. In FIG. 14, FIG. 15 and FIG. 18 to FIG. 20, the finished shaft 108, which is partially polygonal at its outer circumference, i.e., a shaft 108 with a partially non-circular cross-section, is shown.

The blank 101 represents the starting material for producing the shaft 108. The shaft 108 shown in FIG. 14 has a first shaft portion 105 with a first inner diameter i1 and a first outer diameter a1, and a second shaft portion 106 with a second inner diameter i2 and a second outer diameter a2. The blank 101 is cylindrical, partially hollow with a central cavity 104. In the present embodiment, the blank 101 is an extruded blank closed at one end. Thus, the blank 101 is formed closed at a first end face and open at a second end face opposite this first end face, wherein the opening at the second end face is a part of the central cavity 104 of the blank 101.

A radial forging device for producing the shaft 108, which is partially polygonal at the outer circumference, comprises four forging tools, namely forging hammers 103, which are arranged centrally symmetrically about a forging axis 102 and can be driven in the sense of radial working strokes. The radial forging device further comprises a forging mandrel, which is located at least partially in the cavity 104 of the blank 101 during a forging operation.

Furthermore, the radial forging device comprises a clamping head for holding the blank 101, wherein the blank 101 is held on the clamping head at its closed end face. The radial forging device also comprises a counter-holder for axial support of the blank 101. The blank 101 is thus held between the clamping head and the counter-holder during the forging process or the individual forging operations.

The counter-holder includes a base and a counter-holder mandrel applied to the base. The counter-holder mandrel is formed in such a way that it can extend partially, axially into the central cavity 104 of the blank 101.

The counter-holder mandrel is formed in two parts, wherein a first part of the counter-holder mandrel is an inner part and a second part of the counter-holder mandrel is an outer part surrounding the inner part.

The outer part is designed to be axially movable relative to the inner part.

The inner part has a smaller outer diameter compared to the outer part. The outer part thus has a larger outer diameter than the inner part.

The counter-holder mandrel of the counter-holder has a greater axial extent than the central cavity 104 of the blank 101.

The counter-holder, the clamping head and the forging mandrel of the radial forging device are axially movable along a guide bed. The forging hammers 103 of the radial forging device can be moved radially.

The method for producing the shaft 108 of FIG. 14, which is partially polygonal at the outer circumference, by way of radial forging comprises the following steps:
providing a cylindrical blank 101 with a through-hole at least partially penetrating this blank 101 and forming the central cavity 104 of the blank 101 (extruded blank closed at one end: FIG. 12),
clamping the blank 101 in the clamping head of the radial forging device so that an opening of the central cavity 104 is located on a front side of the blank 101 facing away from the clamping head,
axially moving the clamping head with the clamped blank 101 toward a first portion of the blank 101. Axially feeding a counter-holder so that a counter-holder mandrel, namely an inner part and an outer part of the counter-holder mandrel, axially completely penetrate the central cavity 104 of the blank 101 as far as a defined stop, wherein the blank 101 is preloaded via the outer part,
radially feeding the forging hammers 103 toward the first portion of the blank 101,
circularly forging the first portion of the blank 101 into a first shaft portion 105 having a first inner diameter i1 and a first outer diameter a1, wherein the blank 101 rotates,
radially releasing the first shaft portion 105 by the forging hammers 103,
axially moving the outer part of the counter-holder mandrel toward the base of the counter-holder out of the central cavity 104 of the blank 101, wherein the blank 101 is preloaded at the end face via the outer part,
axially moving the clamping head with the clamped blank 101 toward a second portion of the blank 101 so that the inner part lies in the region of the second portion and only partially breaks through the cavity 4,
radially feeding the forging hammers 103 toward the second portion of the blank 101,
circularly forging the second portion of the blank 101 into a second shaft portion 106 having a second inner diameter i2 and a second outer diameter a2, wherein the blank 101 rotates.
radially releasing the second shaft portion 106 by the forging hammers 103,
axially moving the inner part toward the base of the counter-holder out of the central cavity 104 of the blank 101, wherein the blank 101 is further preloaded at the end face via the outer part,
axially moving the clamping head and the counter-holder with the clamped blank 101 toward the first shaft portion 105,
radially feeding the forging hammers 103 toward the first shaft portion 105,
polygon forging the first shaft portion 105, wherein the blank 101 is not subjected to a rotational speed, i.e., does not rotate,
radially releasing the first shaft portion 105 by the forging hammers 103.

In the present exemplary embodiment, the circular forging of the second portion of the blank 101 is carried out in one and the same radial forging device as the circular forging of the first portion, wherein the radial forging device has a specially designed counter-holder or counter-holder mandrel for this purpose. However, forging of the second portion in a separate radial forging device is also conceivable. Furthermore, it is also conceivable to “polygon forge” “the blank directly, without a preceding circular forging process.

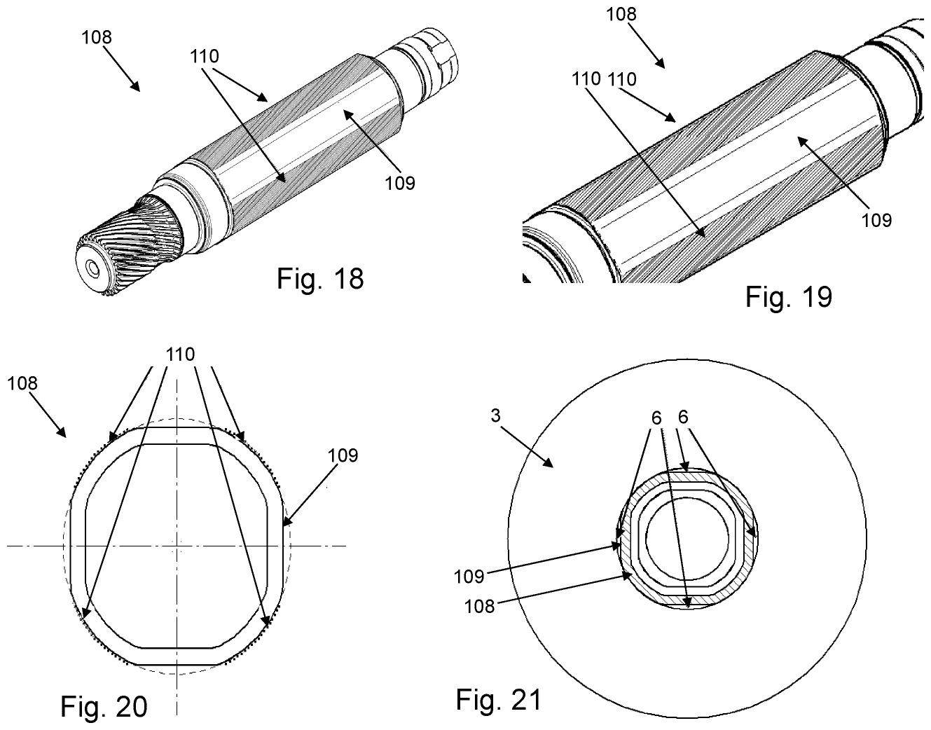

A shaft 108 according to the present disclosure is also shown in FIG. 18 to FIG. 21, wherein the shaft 108 in regions with non-circular cross-section is produced by radial forging without subsequent machining finishing, so that the regions with non-circular cross-section of the rotor shaft 108 are raw and have a forging skin 109.

Regions with a circular cross-section of the rotor shaft 108 were machined after radial forging of the rotor shaft 108, in particular ground, so that the regions with a circular cross-section of the rotor shaft 108 do not have a forging skin but form grinding regions 110.

FIG. 21 shows such a rotor shaft 108 radially inwardly in the rotor core 3, so that axially extending channels 6 are formed between the non-circular regions of the rotor shaft 108 which have the forging skin 109 and the regions of the rotor core 3 lying radially outwardly thereof.

### LIST OF REFERENCE SIGNS

1 rotor
2 electric machine
3 rotor core
4 rotor shaft
5 lateral surface (of the rotor shaft)
6 axially extending channels
7 central cavity
8 radial transverse bore
9 first portion
10 second portion
11 third portion
12 fluid supply path
13 fluid discharge path
16 end cap
17 ring-shaped channel (annular channel)
20 fluid-conducting element
21 further ring-shaped channel (further annular channel)
23 axis of rotation (of the rotor shaft)
24 first end cap
25 second end cap
26 rotor lance
27 centrifugal lug
28 tip (of the arrow-shaped geometry)
31 third end cap
33 arrow (direction of fluid flow)
34 sealing element
35 stator
101 blank
102 forging axis
103 forging hammer
104 central cavity
105 first shaft portion
106 second shaft portion
107 directional arrow
108 shaft
109 forging skin
110 grinding region
a1 first outer diameter
a2 second outer diameter
i1 first inner diameter
i2 second inner diameter

1. A rotor for an electric machine, the rotor comprising:
a rotor core, and
a rotor shaft,
wherein the rotor core is fixed on the rotor shaft, and
wherein the rotor shaft has, at least in some regions, a non-circular cross-section so that, at least in some regions, a plurality of axially extending channels are formed between the rotor core and a lateral surface of the rotor shaft,
wherein at least one region with the non-circular cross-section of the rotor shaft has a forging skin, wherein the forging skin is produced by radial forging without subsequent machining, so that the region with the non-circular cross-section of the rotor shaft has the forging skin.

2. The rotor as claimed in claim 1,
wherein at least one region with a circular cross-section of the rotor shaft has no forging skin, wherein the at least one region with the circular cross-section is machined after radial forging of the rotor shaft, so that the region with a circular cross-section of the rotor shaft has no forging skin.

3. The rotor as claimed in claim 1,
wherein the non-circular cross-section of rotor shaft is a polygonal cross-section.

4. The rotor as claimed in claim 1,
wherein the rotor shaft is at least partially hollow with a central cavity and has at least one radially running transverse bore that connects the central cavity directly or indirectly, namely via an annular channel, to the at least one axially extending channel between the lateral surface of the rotor shaft and the rotor core.

5. The rotor as claimed in claim 1, wherein the rotor shaft is a multi-part rotor shaft, wherein individual parts of the multi-part rotor shaft are fixedly connected to one another.

6. The rotor as claimed in claim 4, wherein the rotor shaft has a first portion, a second portion and a third portion, wherein the second portion lies in an axial direction between the first portion and the third portion, wherein the rotor core is fixed on the rotor shaft in the region of the second portion, and wherein the second portion has the non-circular cross section, so that a plurality of axially extending channels are formed between the rotor core and the lateral surface of the rotor shaft in the region of the second portion of the rotor shaft.

7. The rotor as claimed in claim 6,
wherein a fluid supply path and/or a fluid discharge path is formed in the region of the first portion and/or the second portion and/or the third portion.

8. The rotor as claimed in claim 7,
wherein the central cavity forms the fluid supply path and/or the fluid discharge path.

9. The rotor as claimed in claim 8,
wherein the central cavity of the rotor shaft extends through the first portion into the second portion of the rotor shaft and forms the fluid supply path, wherein the central cavity is connected to the lateral surface of the rotor shaft in the region of at least one axially running channel via at least one radially running transverse bore, wherein the fluid supply path flows in a first axial direction through the cavity and in both the first axial direction and a second axial direction through the at least one axially running channel.

10. The rotor as claimed in claim 6, wherein an end cap is fixed on the rotor shaft in the region of the first portion and/or in the region of the third portion, adjacently to the second portion, and the end cap is further fixed to the rotor core.

11. The rotor as claimed in claim 10,
wherein the end cap forms a channel, which is ring-shaped in cross-section, radially between the rotor shaft and the end cap, wherein the ring-shaped channel is connected to the axially running channels in the region of the second portion and additionally is connected to the central cavity, in the region of the first portion and/or in the region of the third portion, via at least one radial transverse bore in the first portion of the rotor shaft and/or in the third portion of the rotor shaft, wherein the central cavity forms the fluid supply path and/or the fluid discharge path.

12. The rotor as claimed in claim 5, wherein a fluid-conducting element is formed or arranged in the axial direction between the individual parts of the rotor shaft.

13. The rotor as claimed in claim 12,
wherein the fluid-conducting element is arranged axially between the first portion and the second portion of the rotor shaft and/or axially between the second portion and the third portion of the rotor shaft.

14. The rotor as claimed in claim 13,
wherein the fluid-conducting element is circular in cross-section and has at least one radially running transverse bore and a further ring-shaped channel in the region of its outer circumference, wherein the radially running transverse bore connects the central cavity of the rotor shaft, in the region of the first portion and/or the third portion of the rotor shaft, to the further ring-shaped channel, wherein the further ring-shaped channel is further connected to the axially extending channels in the region of the second portion of the rotor shaft.

15. An electric machine comprising
a stator,
a rotor comprising:
a rotor core, and
a rotor shaft,
wherein the rotor core is fixed on the rotor shaft, and
wherein the rotor shaft has, at least in some regions, a non-circular cross-section so that, at least in some regions, a plurality of axially extending channels are formed between the rotor core and a lateral surface of the rotor shaft,
wherein at least one region with the non-circular cross-section of the rotor shaft has a forging skin, wherein the forging skin is produced by radial forging without subsequent machining, so that the region with the non-circular cross-section of the rotor shaft has the forging skin, and
a cooling circuit,
wherein the axially extending channels of the rotor define the cooling circuit.

16. A method for producing a rotor comprising a rotor core and a rotor shaft, wherein the rotor core is fixed on the rotor shaft, wherein the rotor shaft has, at least in some regions, a non-circular cross-section so that, at least in some regions, a plurality of axially extending channels are formed between the rotor core and a lateral surface of the rotor shaft, the method comprising:
providing a blank;
rotating the blank;
producing the at least one region with non-circular cross-section of the rotor shaft by radial forging the blank without subsequent machining, wherein the blank is not rotated in a final radial forging operation, and
producing a forging skin on at least one region with the non-circular cross-section by radial forging without subsequent machining.

17. The method as claimed in claim 16,
wherein at least one region with a circular cross-section of the rotor shaft is machined after radial forging of the rotor shaft.

18. The method as claimed in claim 17, wherein the at least one region with a circular cross-section has no forging skin.

19. The method of claim 17, wherein the blank is a tube open at both ends or an extruded blank closed at one end, wherein the step of providing the blank comprises providing a substantially cylindrical blank, further comprising, prior to the final radial forging operation, radially forging at least one shaft portion with the blank rotating.

20. The rotor as claimed in claim 8, wherein the central cavity of the rotor shaft extends through the first portion and the second portion and into the third portion of the rotor shaft and forms the fluid supply path, wherein the central cavity is connected to the lateral surface of the rotor shaft in the region of at least one axially running channel via at least one radially running transverse bore, wherein the fluid supply path flows in a first axial direction through the cavity and in a second axial direction through the at least one axially running channel that is opposite the first axial direction.
